(19) United States
(12) Patent Application Publication
(10) Pub. No.: US 2012/0318860 A1
(43) Pub. Date: Dec. 20, 2012

(54) AUTHENTICATION LABEL APPLIED OVER BARCODE WITH BARCODE STILL BEING READABLE

(75) Inventors: Dane Fitzgerald Anderson, Lewiston, UT (US); Michael G. Fickes, Kennett Square, PA (US)

(73) Assignee: E.I. DU PONT DE NEMOURS AND COMPANY, Wilmington, DE (US)

(21) Appl. No.: 13/324,417

(22) Filed: Dec. 13, 2011

Related U.S. Application Data
(60) Provisional application No. 61/424,188, filed on Dec. 17, 2010.

(51) Int. Cl. G06K 5/00; G03H 1/18; G03H 1/02

(52) U.S. Cl. 235/375; 359/2

(57) ABSTRACT

A method and element for both authenticating and labeling a product or packaging for a product utilizes a hologram label that is applied over a barcode, such that the barcode and label can be located in the same space on the product or packaging to minimize space requirements. The underlying barcode can still be read using conventional barcode readers, such as laser scanners and image scanners. The barcode can be of various types including both linear barcode and two-dimensional barcode. The barcode is advantageously read with a barcode reader which is positioned at an acute angle with respect to a normal line to a surface bearing the barcode.

### FIELD OF THE INVENTION

This invention is in the field of holograms and holographic imaging being applied for authentication/security and product labeling purposes.

### BACKGROUND OF THE INVENTION

Product manufacturers often want to both authenticate their product(s) and also apply barcode information for product identification and inventory purposes in the same general space on a product or a packaging for a product. If the barcode is applied on top of a product label, it damages the viewability of image(s) on the product label. Furthermore, for many typical size labels, generally the area is too small on the label for long or large barcodes. It would be highly desirable if a barcode could be printed on a product label or package or on a product itself and then have a clear product label applied over the barcode such that the barcode could still be read by current standard barcode readers. The present invention provides for this desirable feature using a holographic label.

Some specialized barcodes can be placed on top of product labels such that the labels are still viewable but they require use of special barcode readers. As one example, a transparent UV fluorescent barcode can be placed on a holographic label where the label is still viewable, but a special fluorescent reader is required to read this specialized barcode.

Holographic labels for product labeling can be manufactured using holography and holographic imaging techniques, which are briefly described next.

Holography is a form of optical information storage. The general principles are described in a number of references, e.g., “Photography by Laser” by E. N. Leith and J. Upatnieks in SCIENTIFIC AMERICAN, 212, No. 6, 24-35 (June, 1965). In brief, the object to be photographed or imaged is illuminated with collimated light, e.g., from a laser, and a light sensitive recording medium, e.g., a photographic plate, is positioned so as to receive light reflected from the object. Each point on the object reflects light to the entire recording medium, and each point on the medium receives light from the entire object. This beam of reflected light is known as the object beam. At the same time, a portion of the collimated light is beamed by a mirror directly to the medium, by-passing the object. This beam is known as the reference beam. What is recorded on the recording medium is the interference pattern that results from the interaction of the reference beam and the object beam impinging on the medium. When the processed recording medium is subsequently illuminated and observed appropriately, the light from the illuminating source is diffracted by the hologram to reproduce the wave-front that originally reached the medium from the object, so that the hologram resembles a window through which the virtual image of the object is observed in full three-dimensional form, complete with parallax.

Holograms that are formed by allowing the reference and object beams to enter the recording medium from the same side are known as transmission holograms and are also known as front beam holograms. Interaction of the object and reference beams in the recording medium forms fringes of material with varying refractive indices which are normal or near normal to the plane of the recording medium. When the hologram is played back by viewing with transmitted light, these fringes diffract the light to produce a viewable virtual image. Such transmission holograms may be produced by methods which are well known in the art, such as those disclosed in U.S. Pat. No. 3,506,327; U.S. Pat. No. 3,838,903 and U.S. Pat. No. 3,894,787.

Holograms formed by allowing the reference and object beams to enter the recording medium from opposite sides, so that they are traveling in approximately opposite directions, are known as reflection holograms and are also known as back beam holograms. Interaction of the object and reference beams in the recording medium forms fringes of material with varying refractive indices which are, approximately, planes parallel to the plane of the recording medium. When the hologram is played back these fringes act as mirrors reflecting incident light back to the viewer. Hence, the hologram is viewed in reflection rather than in transmission. Since the wavelength sensitivity of this type of hologram is very high, white light may be used for reconstruction. Reflection holograms produced by an off-axis process are disclosed in U.S. Pat. No. 3,532,406.

### SUMMARY OF THE INVENTION

The present invention provides for the following desirable feature: When a barcode is printed on a product label or package or on a product itself, and then a clear label (e.g., holographic label) is applied over all or part of the barcode, the barcode can still be read by a barcode reader, thus saving space—both authentication and barcode product information can now be achieved simultaneously in the same limited space—a major advantage for many applications.

In an embodiment, the invention is a method for both authenticating and labeling a product or a packaging for the product, the method comprising:
a) applying a barcode to the product or the packaging for the product;
b) applying a hologram label over the barcode, the hologram label playing back in the visible region of the electromagnetic spectrum; and
c) reading the barcode under the hologram label with a conventional barcode reader.

In another embodiment, the invention is an element comprising:
a) a barcode on a substrate: and
b) a volume phase reflection hologram label applied above the barcode on the substrate, the hologram label playing back with visible light;
wherein the barcode can be read through the hologram label using a conventional barcode reader.
   The substrate can be a product and/or packaging for a product.

### DETAILED DESCRIPTION

In an embodiment (as indicated above), the invention is a method for both authenticating and labeling a product or a packaging for the product. In brief, the method involves first applying a barcode to the product or the packaging for the product, next applying a volume phase reflection hologram label over the barcode, and thence reading the barcode under the hologram label with a conventional bar code reader.

In this method, the volume phase reflection hologram plays back in the visible region of the electromagnetic spectrum. Visible light is utilized in operation of the conventional barcode reader. The visible light involved in playback and used in the barcode reader can be either white light or any portion of the visible light having wavelength(s) ranging from 460 nm to 630 nm. The visible light can be chosen to be associated with any color within the visible region of the electromagnetic spectrum.

The method can utilize various types of barcode readers. In an embodiment, the barcode reader is selected from the group consisting of a laser scanner and an image scanner.

In an embodiment of the method, the barcode reader is a laser scanner. In an embodiment, the laser scanner can be, but is not limited to, a laser scanner operating with red light. In an embodiment, the laser scanner can be, but is not limited to, a laser scanner operating with green light.

In another embodiment of the method, the barcode reader is an image scanner operating with white light. In an embodiment, the white light is room light provided by common room lighting that includes, but is not limited to, incandescent lighting and fluorescent lighting. Use of LED (light-emitting diode) lighting and sunlight are also feasible.

In an embodiment of the method, the barcode is read with the conventional barcode reader positioned at an acute angle ranging from one degree to eighty degrees with respect to a normal line to a surface bearing the barcode. In various embodiments, the barcode reader at an angle (with respect to normal) ranging from 5 to 50 degrees and ranging from 15 to 25 degrees. An angle ranging from 15 to 25 degrees is preferred since a barcode reader affords a faster reading of a barcode when positioned within this angular range (compared to its being positioned outside of this range).

In an embodiment of the method, the volume phase reflection hologram label contains at least one portion that is red in color and the barcode is readable using a laser scanner operating with red light.

In another embodiment of the method, the volume phase reflection hologram label contains at least one portion that is a color corresponding to a region of visible light and the barcode is readable using a laser scanner operating with the visible light.

In an embodiment (as indicated above), the invention is an element comprising:
a) a barcode on a substrate: and
b) a volume phase reflection hologram label applied above the barcode on the substrate, the hologram label playing back with visible light;
   wherein the barcode can be read through the hologram label using a conventional barcode reader. The substrate can be a product and/or packaging for a product.

In an embodiment, the conventional barcode reader used to read the barcode of the element is operated using white light or any portion of the visible light having wavelength(s) ranging from 460 nm to 630 nm.

In an embodiment, the conventional barcode reader used to read the barcode of the element is selected from the group consisting of a laser scanner and an image scanner.

In another embodiment, the conventional barcode reader used to read the barcode of the element is a laser scanner operating with red light.

In another embodiment, the conventional barcode reader used to read the barcode of the element is an image scanner operating with white light.

In yet another embodiment, the volume phase reflection hologram label of the element contains at least one portion that is red in color and the barcode is readable using a laser scanner operating with red light.

In yet still another embodiment, the volume phase reflection hologram label of the element contains at least one portion that is a color corresponding to a region of visible light and the barcode is readable using an image scanner operating with the visible light.

The holographic label of the method and element of this invention can be formed by holographic imaging of a photosensitive material, that can be, but is not limited to, a photosensitive photopolymer composition. One example is use of a photopolymer-based holographic recording film (HRF). Various HRF films are commercially available from E. I. DuPont de Nemours and Company, Inc., Wilmington, Del.

Surprisingly in this invention, a volume phase reflection hologram label can be placed on top of a barcode and yet the barcode that consequently now lies beneath the hologram can still be read when desired using conventional barcode readers. The volume phase reflection hologram diffracts light incident upon it back towards a front face of the hologram, which light might interfere with light being used to operate the barcode reader.

This invention is advantageous in that the barcode needed for authentication of a product (or packaging for a product) can be placed beneath the hologram label being used to label (designate) the product and thereby not adversely affect the appearance of the label (as barcode does when placed in front/on top of the label). And yet the barcode can still be effectively read using conventional barcode scanners.

### GLOSSARY

### Light

Blue light^{a}—Visible light having a wavelength ranging from about 450 nm to about 490 nm. A pure blue color has a corresponding wavelength of about 470 nm associated with it. ^{a}Source: Website: http://en.wikipedia.org/wiki/Color

Green light^{a}—Visible light having a wavelength ranging from about 490 nm to about 560 nm. A pure green color has a corresponding wavelength of about 530 nm associated with it.

Red light^{a}—Visible light having a wavelength ranging from about 635 nm to about 700 nm. A pure red color has a corresponding wavelength of about 700 nm associated with it.

Visible light ^{a}—Electromagnetic radiation that ranges in wavelength from about 390 nm to about 750 nm, which is the range of wavelengths that humans can perceive.

White light—White light is light containing most or all of the colors/wavelengths of light within the visible region (about 390 nm to about 750 nm) of the electromagnetic spectrum combined. Examples of white light include sunlight and ordinary room lighting.

### Scannners

Conventional barcode scanner—A scanner for reading barcodes or other information that is in commercial use as of the filing date of this patent application. Common conventional barcode scanners include laser scanners and various scanners that are held in an operator's hand and operate basically as cameras to take a picture of barcode (or other information being scanned) typically with use of ambient light (e.g., room lighting or sunlight).

Laser scanner—A laser scanner reads barcode using a laser as the source of electromagnetic radiation to detect/verify (i.e., read) a barcode. Most laser scanners are operated using a red laser with output of red light (typically of wavelength 650 nm) but other lasers with output of other colors (e.g, green) of visible light are also known and in use.

### EXAMPLES

### Example 1

A clear monochrome (green) hologram having the IZON® trademark (registered trademark of E. I. DuPont de Nemours and Company, Inc., Wilmington, Del.) was placed over a standard code 128 linear barcode, which contained black lines on a white background and which was barcode for the following text: 1 B3X3Y1. Reading of this barcode through the hologram was done successfully using both a Symbol laser scanner (Symbol Technologies, Inc., Holtsville, N.Y.) that utilizes a red laser and a Handheld image scanner (Hand Held Products, Inc., Skaneateles Falls, N.Y.). Scanning to read the barcode went well such that the barcode was easily read using either scanner.

### Example 2

This example was the same as described in Example 1 except that a code 39 linear barcode was used, which contained black lines on a white background and which was barcode for the following text: 1 B3X3Y1. This barcode was easily read using either of the two scanners.

### Example 3

This example was the same as described in Example 1 except that a Datamatrix 2D barcode was used. Since only image scanners can read 2D barcodes, only the Handheld image scanner was used in this example. This barcode was successfully read with no issue(s).

### Example 4

This example was the same as described in Example 3 except that a QR barcode was used. This barcode was successfully read with no issue(s).

### Example 5

This example was the same as described in Example 3 except that an inverse Datamatrix barcode (having white bars on a dark background) was used. This barcode was successfully read with no issue(s).

### Example 6

This example was the same as described in Example 4 except that an inverse QR barcode (having white bars on a dark background) was used. This barcode was successfully read with no issue(s).

### Examples 7-12

These examples (7-12 in order) were the same as described for Examples 1-6, respectively except that in each of these examples a two color red/green hologram was used in place of the monochrome green hologram used in Examples 1-6. As one specific example, Example 7 was the same as described for Example 1 except that a two color red/green hologram was used in place of the monochrome green hologram of Example 1.

For all Examples 7-12, the two color red/green hologram had at least one area of red and at least one area of green. In each case for Examples 7-12, at least one red portion and at least one green portion of the 2 color hologram covered the barcode as it was being scanned and read by the barcode reader(s).

In all cases for Examples 7-12, the barcodes were successfully scanned and read as described herein with no issue(s).

### Examples 13-18

These examples (13-18 in order) were the same as described for Examples 1-6, respectively except that in each of these examples a two color blue/green hologram was used in place of the monochrome green hologram used in Examples 1-6. As one specific example, Example 13 was the same as described for Example 1 except that a two color blue/green hologram was used in place of the monochrome green hologram of Example 1.

For all Examples 13-18, the two color blue/green hologram had at least one area of blue and at least one area of green. In each case for Examples 13-18, at least one blue portion and at least one green portion of the 2 color hologram covered the barcode as it was being scanned and read by the barcode reader(s).

In all cases for Examples 13-18, the barcodes were successfully scanned and read as described herein with no issue(s).

What is claimed is:

1. A method for both authenticating and labeling a product or a packaging for the product, the method comprising:
a) applying a barcode to the product or the packaging for the product;
b) applying a volume phase reflection hologram label over the barcode, the hologram label playing back with visible light; and
c) reading the barcode under the hologram label with a conventional bar code reader.

2. The method of claim 1 wherein the visible light is white light or any portion of the visible light having wavelength(s) ranging from 460 nm to 630 nm.

3. The method of claim 1 wherein the barcode reader is selected from the group consisting of a laser scanner and an image scanner.

4. The method of claim 1 wherein the barcode is read with the conventional barcode reader positioned at an acute angle ranging from one degree to eighty degrees with respect to a normal line to a surface bearing the barcode.

5. The method of claim 3 wherein the barcode reader is a laser scanner operating with red light.

6. The method of claim 3 wherein the barcode reader is an image scanner operating with white light.

7. The method of claim 6 wherein the white light is room light.

8. The method of claim 1 wherein the volume phase reflection hologram label contains at least one portion that is red in color and wherein the barcode is readable using a laser scanner operating with red light.

9. The method of claim 1 wherein the volume phase reflection hologram label contains at least one portion that is a color corresponding to a region of visible light and wherein the barcode is readable using a laser scanner operating with the visible light.

10. An element comprising:
a) a barcode on a substrate: and
b) a volume phase reflection hologram label applied above the barcode on the substrate, the hologram label playing back with visible light;
wherein the barcode can be read through the hologram label using a conventional barcode reader.

11. The element of claim 10 wherein the conventional barcode reader is operated using white light or any portion of the visible light having wavelength(s) ranging from 460 nm to 630 nm.

12. The element of claim 10 wherein the barcode reader is selected from the group consisting of a laser scanner and an image scanner.

13. The element of claim 12 wherein the barcode reader is a laser scanner operating with red light.

14. The element of claim 12 wherein the barcode reader is an image scanner operating with white light.

15. The element of claim 10 wherein the volume phase reflection hologram label contains at least one portion that is red in color and wherein the barcode is readable using a laser scanner operating with red light.

16. The element of claim 10 wherein the volume phase reflection hologram label contains at least one portion that is a color corresponding to a region of visible light and wherein the barcode is readable using an image scanner operating with the visible light.
